(19) United States
(12) Patent Application Publication
(10) Pub. No.: US 2026/0178837 A1
(43) Pub. Date: Jun. 25, 2026

(54) REAL-TIME EVALUATION FRAMEWORK FOR AI-BASED ASSISTANTS IN COLLABORATIVE ENVIRONMENTS

(71) Applicant: Microsoft Technology Licensing, LLC, Redmond, WA (US)

(72) Inventors: Pritesh Rajesh KANANI, Kirkland, WA (US); Raimond SINIVEE, Roseville, CA (US); Fnu MADHU SUDAN, Mountain View, CA (US); Amod Anil AGASHE, Bothell, WA (US); Ashish GUJARATHI, Parkland, FL (US)

(21) Appl. No.: 19/000,590

(22) Filed: Dec. 23, 2024

(51) Int. Cl. G06F 40/35; G06F 40/40; G06N 3/0475; G06N 3/096

(52) U.S. Cl. CPC G06F 40/35; G06F 40/40; G06N 3/0475; G06N 3/096

(57) ABSTRACT

A system and method for providing real-time feedback on AI-based responses during network-based communication sessions. The system collects and processes session data, including audio, video, transcripts, and user inputs, to create structured workflows. When a user queries an unsatisfactory AI response, the system identifies the transformer sequence responsible, converts it to a session workflow, and matches it to stored workflows. A scoring model then generates a natural language explanation, enhancing user understanding and satisfaction. The system leverages AI models, such as GPT and BERT, to ensure accurate and contextually relevant feedback.

### TECHNICAL FIELD

Embodiments pertain to artificial intelligence and machine learning technologies. Some embodiments relate to real-time evaluation and feedback mechanisms for AI-based assistants during network-based communication sessions.

### BACKGROUND

Artificial Intelligence (AI)-based assistants have become increasingly prevalent in various applications, particularly in the context of network-based communication sessions. These AI-based assistants are designed to enhance user interactions by providing real-time support, automating routine tasks, and facilitating more efficient communication. One function of AI-based assistants is real-time response generation. They generate immediate responses to user inputs during communication sessions, which includes answering queries, providing relevant information, and assisting with tasks based on the context of the conversation. Leveraging natural language processing (NLP) techniques, these assistants can understand and generate human-like responses.

In addition to real-time response generation, AI-based assistants provide task automation abilities. They can automate various routine tasks such as scheduling meetings, setting reminders, and managing to-do lists, thereby helping users save time and reduce the cognitive load associated with managing multiple activities.

Another function of AI-based assistants is contextual understanding where the AI-based assistants utilize advanced machine learning models to analyze the content of communication sessions. The models analyze session audio, video, transcripts, and chat messages, to provide contextually relevant responses and actions. This deep understanding of context allows the assistants to deliver more accurate and useful support for a variety of communication session types including network-based meetings, voice calls, video calls, and the like.

AI-based assistants may also facilitate interactions between multiple participants of a network-based communication session by summarizing key discussion points, detecting conflicts, and synthesizing consensus among participants. They can also manage collaborative tools such as whiteboards, breakout rooms, and shared documents, enhancing the efficiency of group activities.

Overall, AI-based assistants enhance the efficiency, productivity, and user experience of computer-based tasks such as network-based communication sessions. By leveraging advanced AI techniques, these assistants provide support, automate tasks, and facilitate seamless interactions in various professional and personal contexts.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a system diagram illustrating the components of a network-based communication service with AI-based assistants and feedback mechanisms.

FIG. 2 illustrates a data flow diagram showing the feedback mechanism for a generative AI-based assistant during a communication session.

FIG. 3 illustrates a method diagram of a process for providing feedback on AI-based engine responses during network-based communication sessions.

FIG. 4 is a block diagram illustrating an example machine for implementing the techniques discussed in the present disclosure.

### DETAILED DESCRIPTION

Despite their advanced capabilities, AI-based assistants often encounter challenges that may reduce their effectiveness. One significant problem is the lack of real-time, comprehensive evaluation and feedback mechanisms for AI-generated responses during meetings. Users frequently encounter situations where the AI-based assistant fails to perform as expected, leading to unsatisfactory responses or incomplete tasks. For instance, an AI assistant might not turn on a user's video during a presentation or fail to complete a whiteboard drawing as requested. Currently, there does not exist a way to evaluate what happened with the AI-based engine that powers the AI-based assistant. These issues, and the lack of any meaningful feedback, can disrupt the flow of communication and reduce the overall productivity of the meeting.

Disclosed in some examples are methods, systems, devices, and machine-readable mediums which provide root-cause analysis of unsatisfactory responses of an artificial intelligence (AI) based engine (such as those used in an AI-based assistant) during network-based communication sessions by determining the context of user queries related to previous AI responses and generating explanations for the AI's behavior. This is achieved by identifying the failure of the model to process a previous input, understanding the intent of the user query, and utilizing a scoring generative artificial intelligence model to produce a natural language response.

In some examples, the method begins by receiving an input from the user, which may be an instruction to the AI-based engine or a query about why the AI-based engine made an error. The system then determines that the input relates to a failure of the AI-based engine to process a previous input, typically through keyword or key phrase matching. The AI-based engine understands the intent of the question, which influences the embedding and ranking of algorithms. The system then uses a generative artificial intelligence scoring model that identifies one or more transformer sequences of the AI-based engine that most probably caused the response to the user input. This scoring model calculates the transformer sequences based on communication session content data and trained weights and biases of the AI-based engine. The communication session content data may include audio frames, video frames, transcripts, screensharing data, chat messages, the user query, and the response to the user query. The system then converts the transformer sequences to one or more session workflows and finds a most probable session workflow that corresponds to the transformer sequence by vectorizing the transformer sequence and comparing it to stored vectorized session workflows of the communication session. The session workflows are textual representations of events of the communication session—e.g., in JavaScript Object Notation (JSON). One or more of the meeting workflows converted from the transformer sequences are input back into the scoring generative artificial intelligence model to produce a natural language response to the second user query, which is then provided to the user. This natural language response identifies why the AI-based engine of the AI-based assistant did not provide a satisfactory response.

The present disclosure thus solves the technical problem of the lack of real-time, comprehensive evaluation and feedback mechanisms for AI-generated responses such as during network-based communication sessions. Users frequently encounter situations where the AI-based assistant fails to perform as expected, leading to unsatisfactory responses or incomplete tasks, such as not turning on a user's video during a presentation or failing to complete a whiteboard drawing as requested. These issues can disrupt the flow of communication and reduce the overall productivity of the communication session or other task being performed. The present disclosure provides technical solutions involving methods, systems, devices, and machine-readable mediums which perform root-cause analysis of unsatisfactory responses of an AI-based engine. This is achieved by determining the context of user queries related to previous AI responses and generating explanations for the AI's behavior. The system identifies the failure of the AI-based engine to process a previous input, understands the intent of the user query, and utilizes a scoring generative artificial intelligence model to produce a natural language response. The method includes receiving an input from the user, determining that the input relates to a failure of the AI-based engine to process a previous input through keyword or key phrase matching, and identifying the transformer sequence of the AI-based engine that most probably caused the response. This sequence is then converted to a session workflow by vectorizing the transformer sequence and comparing it to stored vectorized session workflows. The meeting workflow converted from the transformer sequence is input into the scoring generative artificial intelligence model to produce a natural language response to the second user query, which is then provided to the user. The present disclosure treats communication session workflows as a modality in itself (or a scaffold of multiple modalities).

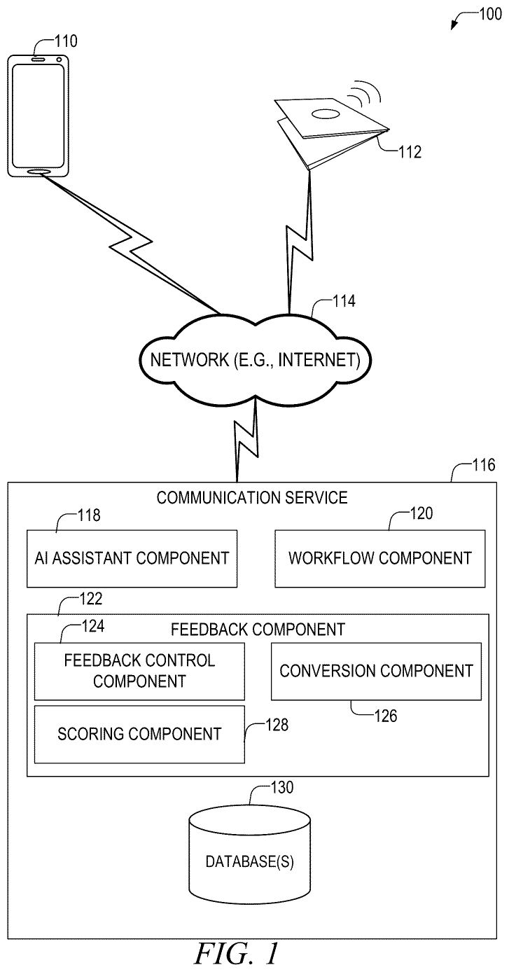

FIG. 1 illustrates a system 100 of a network-based communication service which provides AI-based engines that offer AI-based assistants and feedback according to some examples of the present disclosure. The system 100 includes user devices such as a mobile device 110 and a laptop 112, both of which connect to the communication service 116 over a network 114, such as the Internet. The network 114 facilitates communication between the devices and a communication service 116.

The communication service 116 comprises several components and manages communication sessions between the mobile device 110, laptop 112, and other computing devices. Communication sessions may be network-based meetings, video calls, voice calls, chat sessions, file sharing, or the like. An AI assistant component 118 provides AI-based assistance during communication sessions, including generating responses to user inputs and performing tasks based on the context of the conversation. The AI assistant component 118 may include an AI engine which may be a generative AI model that utilizes communication session context to provide responses. The generative AI model may be a Generative Pre-trained Transformer (GPT), a large language model (LLM), small language model (SLM), or the like.

A workflow component 120 monitors events of the communication session and documents these session events into workflows, which are textual representations of the sequence of actions and events during the communication sessions. These workflows provide an understanding of the context and flow of the meeting, enabling the system to provide accurate and contextually relevant responses.

The workflow component 120 operates by first collecting communication session content data, which may include audio frames, video frames, transcripts, screensharing data, chat messages, user queries, and AI responses. This data is then processed to identify events and actions that occurred during the session. In some examples, the workflow component 120 is a trained machine-learning model that is trained to identify and document workflows. In other examples, the workflow component 120 may generate workflows based upon rules, such as if-then-else rules. In some examples, the workflow component 120 sequences these events hierarchically based on time, context, and modality (e.g., audio, video, screenshare, canvas). It may then index these sequences to create a coherent workflow that represents the flow of the meeting. These workflows may be formatted in a structured format such as JSON, extensible Markup Language (XML), or the like, which allows for easy parsing and analysis.

A context synchronizer may also be a part of the workflow component 120 (not shown for clarity). The context synchronizer maintains a real-time buffer for different dimensions (state, time, length of actions) that govern the AI assistant's memory and actions. The context synchronizer adapts weights for evaluation context and allocates the appropriate context for the evaluation of the prompt. It combines various meeting components, such as chat, transcript (audio), AI agents, meeting canvases (whiteboard), and media (video, app sharing elements), and in-meeting interactions (likes, sentiments, etc.). This ensures that the AI assistant has a comprehensive understanding of the meeting context, enabling it to provide more accurate and contextually relevant responses.

The context synchronizer also collects weights for different workflows, which are used to dynamically adjust the importance of various meeting components based on the context of the discussion. For example, during a presentation, the context synchronizer may prioritize video and audio data by increasing weights assigned to those workflows, while during a collaborative brainstorming session, it may prioritize whiteboard interactions and chat messages by increasing weights associated with those workflows.

A feedback component 122 includes multiple sub-components that work together to handle user complaints and generate appropriate responses. When a user complains or queries about an unsatisfactory response from the AI assistant, the AI assistant component 118 determines that the context of the query relates to feedback about its performance and so the AI assistant component 118 engages the feedback control component 124. The feedback control component 124 manages the feedback process, ensuring that the complaint is properly logged, processed, and a response is provided.

The feedback control component 124 engages the scoring component 128, which evaluates the performance and accuracy of the AI-based response using a scoring generative artificial intelligence model. This model calculates one or more transformer sequences that are most probably a cause of the response from the AI assistant component 118 based on the communication session content data of the communication session and trained weights and biases of the AI-based engine. In some examples, the scoring component 128 is a fine-tuned GPT model.

Next, the output of the scoring model (a transformer sequence) is passed to the conversion component 126. The conversion component 126 converts the transformer sequence into a workflow and finds a matching workflow from the current session's workflows (e.g., stored in the database 130). In some examples, the conversion is done using another fine-tuned GPT model, a regression model, neural network or the like. These models may be trained on transformer examples that have labelled workflows. In some examples, the conversion may be done using rulesets such as if-then-else rules. The conversion component 126 may then try and match the workflow to a workflow of the ongoing communication session. This may be done by taking a vectorized representation of the workflow produced by the conversion component 126 and comparing it with vectorized workflows of the current communication session. The comparison, in some examples, is a cosine similarity.

Once the matching workflow is identified, the scoring component 128 is used again to generate a natural language response to the user's query. This response is based on the context and content of the identified workflow, and the result is a natural language output providing an explanation for the AI's behavior. The natural language response is then delivered back to the user, addressing their complaint and providing insights into why the AI assistant performed as it did.

The communication service 116 also includes one or more databases 130, which store data related to the communication sessions, including user inputs, AI responses, session workflows, and evaluation metrics. This stored data is used to fine-tune the AI models and improve the accuracy and relevance of the responses over time.

The scoring model of the scoring component is fine-tuned using a comprehensive dataset collected from a plurality of network-based communication sessions. This dataset includes communication session content data such as audio frames, video frames, transcripts, screensharing data, chat messages, user queries, and AI responses. The collected data is labeled with corresponding workflows and outcomes, which are used to train the scoring generative artificial intelligence model. The training process involves fine-tuning the model by adjusting the weights and biases to learn the relationships between communication session content data, workflows, and outcomes. This enables the model to accurately identify the transformer sequences that most likely caused specific responses and to generate contextually appropriate natural language explanations for user queries.

The system 100 enables real-time interaction and feedback for users during network-based communication sessions, leveraging AI-based engines to enhance the overall user experience. By providing root-cause analysis of unsatisfactory responses and generating explanations for the AI's behavior, the system ensures that users receive accurate and contextually appropriate assistance, thereby improving the efficiency and productivity of the communication sessions.

As previously described, the system converts events of a meeting into specific worfklows. Workflows may describe session capabilities such as the specific features of the session setup and the availability of advanced collaboration tools. Examples include data related to breakout rooms such as: the number of breakout rooms, a list of participants of each room, an engagement level with the AI-based assistant in each room, a list of topics discussed in each room generated by analysis of the chat and audio from each room, whether a whiteboard or diagram was used or shared, a metric of content explanation quality (e.g., whether the user explained shared content). Examples may also include information about a whiteboard, such as the number of interactions with the whiteboard, a measure of the complexity of drawings on the whiteboard, tags generated from text recognized in sketches, and/or a vector representation of the whiteboard content.

Workflows may include information on the usage of the AI-based assistant, such as engagement level, a response tone chosen by a user, a score based upon a legibility of the AI-based assistant's answers, a task completion percentage that indicates whether the AI-based assistant completed the user's requested tasks, a measure of whether the AI-based assistant suggested unexpected but useful solutions, feedback of how “smart” the assistant appeared, and the like. Some features relate to a personal assistant, but group-based assistants (where the entire group collaborates using an assistant) may include the same or additional information such as a number of participants that are engaged, whether there was a detected conflict over resource allocation, and/or the like.

Workflows may include information on audio, video, screenshare, image view, and canvas modalities. Example audio information may include a number of unique speakers, a speaker hierarchy that ranks the activity of speakers, a metric of how clear participant's speech was, whether a user's sentiment was positive or negative, whether and how often a user was interrupted, a total speaking time, and lists of devices users utilized. Example video information may include a number of active video streams, facial expression analysis (e.g., emotions of users), video quality metrics, frame rates, attention levels of participants, whether participants turned off their video and/or back on during the session. Example screenshare modalities included a number of screensharing events, a screenshare duration, a list of content types shared (e.g., PowerPoint slides, Excel spreadsheets, browser window), metrics related to screenshare quality, screenshare start/stop count, a metric indicating an interaction level with screenshare (e.g., whether participants referenced the shared content frequently in the discussion). Example image view modality information may include a number of images viewed, an image resolution, a metric indicating a relevance of images (e.g., images directly related to the presentation and agenda items have a higher relevance), a metric indicating an interaction level with images (e.g., how often the images were referenced), a time spent viewing the images, and the like. Canvas view modality information may include, a number of canvas views utilized, a number of annotations on the canvas, an interaction duration, a collaboration level, a relevance of the canvas to an agenda, a complexity level of the canvas, and the like.

In some examples, the workflow information may be determined, e.g., by the AI-based assistant and may be recorded for the meeting. The context synchronizer utilizes the workflow information to create the different dimensions. These workflow sequences may be converted to and from internal transformer-based representations that are used within the scoring and/or AI-based assistant.

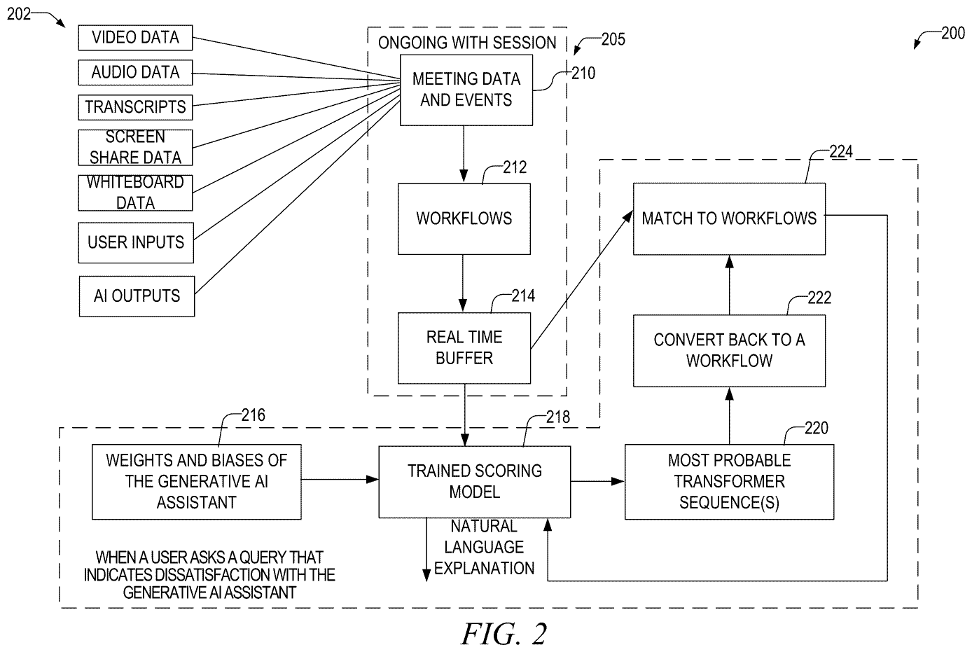

FIG. 2 illustrates a data flow 200 showing a feedback mechanism for a generative AI-based assistant according to some examples of the present disclosure. The data flow 200 begins with session data types 202, which include video data, audio data, transcripts, screen share data, whiteboard data, user inputs, and AI outputs produced during the communication session. This data may be produced by one or more participant computing devices of the communication session. These data types are collected and processed during an ongoing session 205 as the session progresses. The meeting data and events 210 represents an aggregate of the various session data types 202. This data is used to capture real-time interactions and events occurring during the session, forming the basis for subsequent analysis and processing.

This data is transformed into structured workflows 212. These workflows 212 represent the sequence of actions and events during the session, providing a coherent representation of the session's flow. As previously described, these workflows may be formatted in some examples into a structured format such as JSON, which allows for easy parsing and analysis. The workflows may be sequenced to relate separate workflows together. These sequenced workflows may be stored in a real-time buffer 214 that temporarily stores the structured workflows 212, allowing for immediate access and processing.

Upon receiving a complaint about the quality of a response of the generative AI assistant, the system evaluates the response. For example, the weights and biases of the generative AI assistant 216 store the trained parameters of the AI engine used by the AI-based assistant. These parameters influence the AI assistant's behavior and response generation during the session. The trained scoring model 218 component evaluates the performance and accuracy of the AI assistant's responses. This model uses the weights and biases of the generative AI assistant 216 and the workflow sequences from the real-time buffer 214 to generate one or more most probable transformer sequences 220 that caused the response.

The transformer sequences are converted back to one or more workflow sequences 222. These sequences are then matched to the stored structured workflows 212. For example, each of the workflow sequences 222 and the workflow sequences stored in the real-time buffer 214 may be converted to a vectorized representation and a cosine similarity may be used to find matching sequences.

The matching workflow sequences 224 may be used as input to the trained scoring model 218 to generate a natural language explanation. This explanation is provided to the user, addressing their query and providing insights into the AI assistant's behavior during the session.

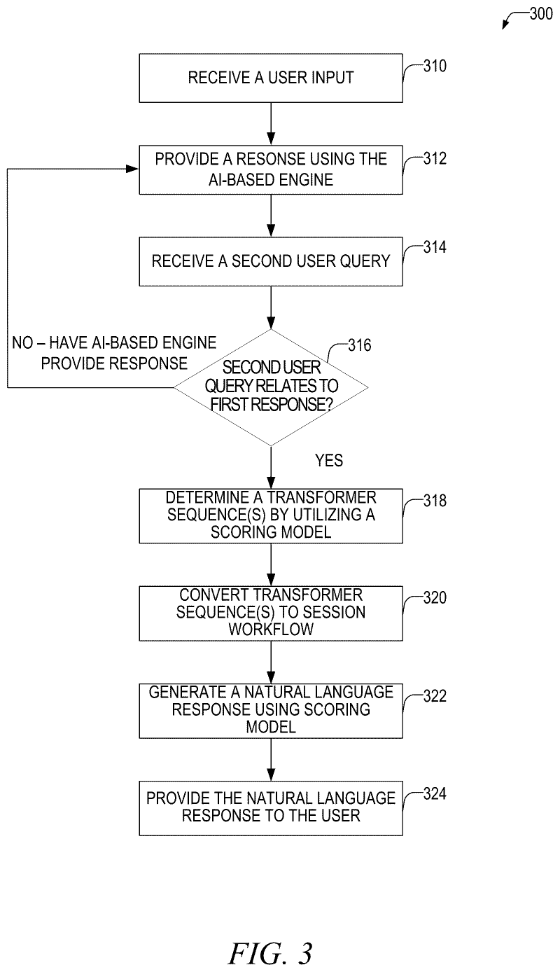

FIG. 3 shows a flowchart of a method 300 of providing feedback on why an AI-based engine provided a particular response according to some examples of the present disclosure.

At operation 310, the system receives a user input. This input may be an instruction to the AI-based engine or a query about a specific task or action. At operation 312, the system provides a response to the user input using the AI-based engine. This response is generated based on the AI engine's understanding and processing of the initial user input and the workflows associated with the communication session.

At operation 314, the system receives a second user query. This query typically relates to the response provided by the AI-based engine in operation 312. At operation 316, the system determines whether the second user query relates to the first response. This involves checking if the context of the second query is about the response to the initial user input. If the second user query does not relate to the first response, the system proceeds to provide a new response using the AI-based engine.

If the second user query does relate to the first response, the system proceeds to operation 318. At operation 318, the system determines a transformer sequence(s) by utilizing a scoring model. This involves identifying the sequence of operations or processes within the AI-based engine that most likely led to the initial response. This may be based upon communication session content data (such as workflow sequences) and trained weights and biases of the AI based engine to a scoring generative artificial intelligence model, the communication session content data in some examples may comprise one or more of: audio frames, video frames, a transcript, screensharing data, chat messages, the user query, and the response to the user query. In some examples, this may be based upon communication session modes—e.g., either broadcast, live transmission, or the like and Human-AI interaction canvases (e.g., a whiteboard, and the like). In some examples, the transformer sequence a data format that encapsulates the communication session content data in a way that is usable by the generative AI models.

At operation 320, the system converts the identified transformer sequence(s) to a session workflow. This conversion involves vectorizing the transformer sequence and comparing the transformer sequence to stored vectorized session workflows to create a coherent representation of the session's events.

At operation 322, the system generates a natural language response using the scoring model. This response is based on the context and content of the identified session workflow, providing an explanation for the AI's behavior.

At operation 324, the system provides the natural language response to the user. This response addresses the user's query and provides insights into why the AI-based engine performed as the AI-based engine did, thereby enhancing the user's understanding and satisfaction.

In some examples, the AI models described herein may be generative AI models, such as Generative Pre-trained Transformer (GPT) models, also referred to as Large Language Models (LLMs). In yet other examples, the models may be other types of natural language models, such as Bidirectional Encoder Representations from Transformers (BERT), Recurrent Neural Networks (RNNs), Long Short-Term Memory (LSTM) networks, or Transformer-XL models. Additionally, the models could include convolutional neural networks (CNNs) for specific tasks like image recognition within the communication session or hybrid models that combine multiple types of neural networks to leverage the strengths of each.

The disclosed system can be integrated with various network-based communication platforms such as Microsoft Teams, Zoom, Google Meet, Cisco Webex, and Slack. This integration allows the AI-based assistant to provide real-time feedback and evaluation across different virtual meeting environments, enhancing the user experience and ensuring consistent performance regardless of the platform used. In addition, the disclosed system may be used with other collaboration environments such as productivity suites (e.g., such as Microsoft Office 365, Google Workspace), customer relationship management systems, and the like. The system's ability to track workflows, index them by time and context, and generate explanations for inactions can help users better understand issues related to task completion and automation in various applications.

In some examples, in addition to a user readable explanation, the system may include an inverse model that allows for reverse traceability through a machine learning model. This model provides an accurate understanding of why the AI assistant failed to execute an intended action, enabling users to debug and improve the AI assistant's performance. The inverse model generates relevance and context vectors, Z-scores, and reverse weights to explain configuration failures and provide actionable insights to users. This may be stored and utilized by developers to understand and improve the AI.

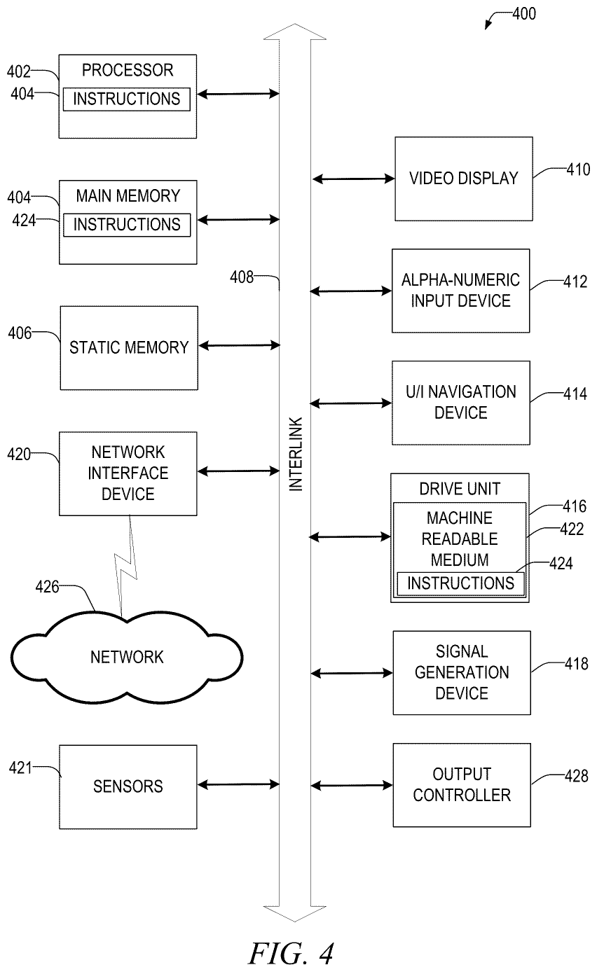

FIG. 4 illustrates a block diagram of an example machine 400 upon which any one or more of the techniques (e.g., methodologies) discussed herein may be performed. In alternative embodiments, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environment. The machine 400 may be in the form of a server computer, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. Machine 400 may implement any one or more of the mobile device 110, laptop 112, a server of communication service 116 which may implement one or more of the components therein, the data flow of FIG. 2, and the method of FIG. 3.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 400 may include one or more hardware processors, such as processor 402. Processor 402 may be a central processing unit (CPU), a graphics processing unit (GPU), a hardware processor core, or any combination thereof. Machine 400 may include a main memory 404 and a static memory 406, some or all of which may communicate with each other via an interlink (e.g., bus) 408. Examples of main memory 404 may include Synchronous Dynamic Random-Access Memory (SDRAM), such as Double Data Rate memory, such as DDR4 or DDR5. Interlink 408 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 400 may further include a display unit 410, an alphanumeric input device 412 (e.g., a keyboard), and a user interface (UI) navigation device 414 (e.g., a mouse). In an example, the display unit 410, input device 412 and UI navigation device 414 may be a touch screen display. The machine 400 may additionally include a storage device (e.g., drive unit) 416, a signal generation device 418 (e.g., a speaker), a network interface device 420, and one or more sensors 421, such as a global positioning system (GPS) sensor, compass, accelerometer, or other sensor. The machine 400 may include an output controller 428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 416 may include a machine readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the machine 400. In an example, one or any combination of the hardware processor 402, the main memory 404, the static memory 406, or the storage device 416 may constitute machine readable media.

While the machine readable medium 422 is illustrated as a single medium, the term “machine readable medium” may include a single medium or multiple media (e.g., a centralized or distributed database, and/or associated caches and servers) configured to store the one or more instructions 424.

The term “machine readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 424 may further be transmitted or received over a communications network 426 using a transmission medium via the network interface device 420. The Machine 400 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 420 may include one or more physical jacks (e.g., Ethernet, coaxial, or phone jacks) or one or more antennas to connect to the communications network 426. In an example, the network interface device 420 may include a plurality of antennas to wirelessly communicate using at least one of single-input multiple-output (SIMO), multiple-input multiple-output (MIMO), or multiple-input single-output (MISO) techniques. In some examples, the network interface device 420 may wirelessly communicate using Multiple User MIMO techniques.

### OTHER NOTES AND EXAMPLES

Example 1 is a method for analysis of unsatisfactory responses of an artificial intelligence (AI) based engine during network-based communication sessions, the method comprising: receiving a first user input; providing a response to the first user input using the AI based engine; receiving a second user input; determining, using the AI based engine, that a context of the second user input is about the response to the first user input previously given by an AI based engine; responsive to determining that the second user input relates to the response to the first user input previously given by an AI based assistant: determining a transformer sequence of the meeting workflow of the AI-based engine that most probably caused the response to the first user input by: utilizing a scoring generative artificial intelligence model to calculate the transformer sequence based upon communication session content data and trained weights and biases of the AI based engine to a scoring generative artificial intelligence model, the communication session content data comprising one or more of: audio frames, video frames, a transcript, screensharing data, chat messages, communication session modes, human-AI interaction canvases, the first user input, and the response to the first user input, the transformer sequence a data format that encapsulates the communication session content data; converting the transformer sequence to a session workflow by vectorizing the transformer sequence and comparing the vectorized transformer sequences to stored vectorized session workflows of the network-based communication session, the session workflows being a textual representation of events of the network-based communication session; inputting the session workflow converted from the transformer sequence to the scoring generative artificial intelligence model to produce a natural language response to the second user input; and providing the natural language response to a user.

In Example 2, the subject matter of Example 1 includes, wherein the communication session content data includes metadata including timestamps and participant identifiers.

In Example 3, the subject matter of Examples 1-2 includes, wherein converting the transformer sequence to the communication session workflow comprises selecting the stored vectorized meeting workflow with a lowest cosine similarity to the vectorized transformer sequence.

In Example 4, the subject matter of Examples 1-3 includes, during the network-based communication session, updating the stored vectorized session workflows based upon new meeting content data received during the meeting.

In Example 5, the subject matter of Examples 1˜4 includes, storing the natural language response and the associated session workflow in a database that is indexed and vectorized based upon a workflow.

In Example 6, the subject matter of Examples 1-5 includes, wherein the scoring generative artificial intelligence model is one of: a Large Language Model (LLM), generative pre-trained transformer (GPT) model, a small language model (SLM).

In Example 7, the subject matter of Example 6 includes, fine tuning the generative pre-trained transformer model, the fine tuning comprising: collecting communication session content data from a plurality of network-based communication sessions; labeling the collected communication session content data with corresponding workflows and outcomes; and fine-tuning the generative pre-trained transformer model using the labeled collected communication session content data to refine the weights and biases of the generative pre-trained transformer model to learn relationships between communication session content data, workflows, and outcomes.

Example 8 is a non-transitory machine-readable medium, storing instructions for analysis of unsatisfactory responses of an artificial intelligence (AI) based engine during network-based communication sessions, the instructions, which when executed, cause the machine to perform operations comprising: receiving a first user input; providing a response to the first user input using the AI based engine; receiving a second user input; determining, using the AI based engine, that a context of the second user input is about the response to the first user input previously given by an AI based engine; responsive to determining that the second user input relates to the response to the first user input previously given by an AI based assistant: determining a transformer sequence of the meeting workflow of the AI-based engine that most probably caused the response to the first user input by: utilizing a scoring generative artificial intelligence model to calculate the transformer sequence based upon communication session content data and trained weights and biases of the AI based engine to a scoring generative artificial intelligence model, the communication session content data comprising one or more of: audio frames, video frames, a transcript, screensharing data, chat messages, communication session modes, human-AI interaction canvases, the first user input, and the response to the first user input, the transformer sequence a data format that encapsulates the communication session content data; converting the transformer sequence to a session workflow by vectorizing the transformer sequence and comparing the vectorized transformer sequences to stored vectorized session workflows of the network-based communication session, the session workflows being a textual representation of events of the network-based communication session; inputting the session workflow converted from the transformer sequence to the scoring generative artificial intelligence model to produce a natural language response to the second user input; and providing the natural language response to a user.

In Example 9, the subject matter of Example 8 includes, wherein the communication session content data includes metadata including timestamps and participant identifiers.

In Example 10, the subject matter of Examples 8-9 includes, wherein converting the transformer sequence to the communication session workflow comprises selecting the stored vectorized meeting workflow with a lowest cosine similarity to the vectorized transformer sequence.

In Example 11, the subject matter of Examples 8-10 includes, wherein the operations further comprise: during the network-based communication session, updating the stored vectorized session workflows based upon new meeting content data received during the meeting.

In Example 12, the subject matter of Examples 8-11 includes, wherein the operations further comprise storing the natural language response and the associated session workflow in a database that is indexed and vectorized based upon a workflow.

In Example 13, the subject matter of Examples 8-12 includes, wherein the scoring generative artificial intelligence model is one of: a Large Language Model (LLM), generative pre-trained transformer (GPT) model, a small language model (SLM).

In Example 14, the subject matter of Example 13 includes, wherein the operations further comprise fine tuning the generative pre-trained transformer model, the fine tuning comprising: collecting communication session content data from a plurality of network-based communication sessions; labeling the collected communication session content data with corresponding workflows and outcomes; and fine-tuning the generative pre-trained transformer model using the labeled collected communication session content data to refine the weights and biases of the generative pre-trained transformer model to learn relationships between communication session content data, workflows, and outcomes.

Example 15 is a computing device for analysis of unsatisfactory responses of an artificial intelligence (AI) based engine during network-based communication sessions, the computing device comprising: a hardware processor; a memory, the memory storing instructions, which when executed by the hardware processor cause the computing device to perform operations comprising: receiving a first user input; providing a response to the first user input using the AI based engine; receiving a second user input; determining, using the AI based engine, that a context of the second user input is about the response to the first user input previously given by an AI based engine; responsive to determining that the second user input relates to the response to the first user input previously given by an AI based assistant: determining a transformer sequence of the meeting workflow of the AI-based engine that most probably caused the response to the first user input by: utilizing a scoring generative artificial intelligence model to calculate the transformer sequence based upon communication session content data and trained weights and biases of the AI based engine to a scoring generative artificial intelligence model, the communication session content data comprising one or more of: audio frames, video frames, a transcript, screensharing data, chat messages, communication session modes, human-AI interaction canvases, the first user input, and the response to the first user input, the transformer sequence a data format that encapsulates the communication session content data; converting the transformer sequence to a session workflow by vectorizing the transformer sequence and comparing the vectorized transformer sequences to stored vectorized session workflows of the network-based communication session, the session workflows being a textual representation of events of the network-based communication session; inputting the session workflow converted from the transformer sequence to the scoring generative artificial intelligence model to produce a natural language response to the second user input; and providing the natural language response to a user.

In Example 16, the subject matter of Example 15 includes, wherein the communication session content data includes metadata including timestamps and participant identifiers.

In Example 17, the subject matter of Examples 15-16 includes, wherein converting the transformer sequence to the communication session workflow comprises selecting the stored vectorized meeting workflow with a lowest cosine similarity to the vectorized transformer sequence.

In Example 18, the subject matter of Examples 15-17 includes, wherein the operations further comprise: during the network-based communication session, updating the stored vectorized session workflows based upon new meeting content data received during the meeting.

In Example 19, the subject matter of Examples 15-18 includes, wherein the operations further comprise storing the natural language response and the associated session workflow in a database that is indexed and vectorized based upon a workflow.

In Example 20, the subject matter of Examples 15-19 includes, wherein the scoring generative artificial intelligence model is one of: a Large Language Model (LLM), generative pre-trained transformer (GPT) model, a small language model (SLM).

In Example 21, the subject matter of Example 20 includes, wherein the operations further comprise fine tuning the generative pre-trained transformer model, the fine tuning comprising: collecting communication session content data from a plurality of network-based communication sessions; labeling the collected communication session content data with corresponding workflows and outcomes; and fine-tuning the generative pre-trained transformer model using the labeled collected communication session content data to refine the weights and biases of the generative pre-trained transformer model to learn relationships between communication session content data, workflows, and outcomes.

Example 22 is at least one machine-readable medium including instructions that, when executed by processing circuitry, cause the processing circuitry to perform operations to implement of any of Examples 1-21.

Example 23 is an apparatus comprising means to implement of any of Examples 1-21.

Example 24 is a system to implement of any of Examples 1-21.

Example 25 is a method to implement of any of Examples 1-21.

What is claimed is:

1. A method for analysis of unsatisfactory responses of an artificial intelligence (AI) based engine during network-based communication sessions, the method comprising:
receiving a first user input;
providing a response to the first user input using the AI based engine;
receiving a second user input;
determining, using the AI based engine, that a context of the second user input is about the response to the first user input previously given by an AI based engine;
responsive to determining that the second user input relates to the response to the first user input previously given by an AI based assistant:
determining a transformer sequence of the AI-based engine that most probably caused the response to the first user input by:
utilizing a scoring generative artificial intelligence model to calculate the transformer sequence based upon communication session content data and trained weights and biases of the AI based engine to a scoring generative artificial intelligence model, the communication session content data comprising one or more of: audio frames, video frames, a transcript, screensharing data, chat messages, communication session modes, human-AI interaction canvases, the first user input, and the response to the first user input, the transformer sequence a data format that encapsulates the communication session content data;
converting the transformer sequence to a session workflow by vectorizing the transformer sequence and comparing the vectorized transformer sequences to stored vectorized session workflows of the network-based communication session, the session workflows being a textual representation of events of the network-based communication session;
inputting the session workflow converted from the transformer sequence to the scoring generative artificial intelligence model to produce a natural language response to the second user input; and
providing the natural language response to a user.

2. The method of claim 1, wherein the communication session content data includes metadata including timestamps and participant identifiers.

3. The method of claim 1, wherein converting the transformer sequence to the communication session workflow comprises selecting the stored vectorized meeting workflow with a lowest cosine similarity to the vectorized transformer sequence.

4. The method of claim 1, further comprising:
during the network-based communication session, updating the stored vectorized session workflows based upon new meeting content data received during the meeting.

5. The method of claim 1, further comprising storing the natural language response and the associated session workflow in a database that is indexed and vectorized based upon a workflow.

6. The method of claim 1, wherein the scoring generative artificial intelligence model is one of: a Large Language Model (LLM), generative pre-trained transformer (GPT) model, a small language model (SLM).

7. The method of claim 6, further comprising fine tuning the generative pre-trained transformer model, the fine tuning comprising:
collecting communication session content data from a plurality of network-based communication sessions;
labeling the collected communication session content data with corresponding workflows and outcomes; and
fine-tuning the generative pre-trained transformer model using the labeled collected communication session content data to refine the weights and biases of the generative pre-trained transformer model to learn relationships between communication session content data, workflows, and outcomes.

8. A non-transitory machine-readable medium, storing instructions for analysis of unsatisfactory responses of an artificial intelligence (AI) based engine during network-based communication sessions, the instructions, which when executed, cause the machine to perform operations comprising:
receiving a first user input;
providing a response to the first user input using the AI based engine;
receiving a second user input;
determining, using the AI based engine, that a context of the second user input is about the response to the first user input previously given by an AI based engine;
responsive to determining that the second user input relates to the response to the first user input previously given by an AI based assistant:
determining a transformer sequence of the meeting workflow of the AI-based engine that most probably caused the response to the first user input by: utilizing a scoring generative artificial intelligence model to calculate the transformer sequence based upon communication session content data and trained weights and biases of the AI based engine to a scoring generative artificial intelligence model, the communication session content data comprising one or more of: audio frames, video frames, a transcript, screensharing data, chat messages, communication session modes, human-AI interaction canvases, the first user input, and the response to the first user input, the transformer sequence a data format that encapsulates the communication session content data;
converting the transformer sequence to a session workflow by vectorizing the transformer sequence and comparing the vectorized transformer sequences to stored vectorized session workflows of the network-based communication session, the session workflows being a textual representation of events of the network-based communication session;
inputting the session workflow converted from the transformer sequence to the scoring generative artificial intelligence model to produce a natural language response to the second user input; and
providing the natural language response to a user.

9. The non-transitory machine-readable medium of claim 8, wherein the communication session content data includes metadata including timestamps and participant identifiers.

10. The non-transitory machine-readable medium of claim 8, wherein converting the transformer sequence to the communication session workflow comprises selecting the stored vectorized meeting workflow with a lowest cosine similarity to the vectorized transformer sequence.

11. The non-transitory machine-readable medium of claim 8, wherein the operations further comprise: during the network-based communication session, updating the stored vectorized session workflows based upon new meeting content data received during the meeting.

12. The non-transitory machine-readable medium of claim 8, wherein the operations further comprise storing the natural language response and the associated session workflow in a database that is indexed and vectorized based upon a workflow.

13. The non-transitory machine-readable medium of claim 8, wherein the scoring generative artificial intelligence model is one of: a Large Language Model (LLM), generative pre-trained transformer (GPT) model, a small language model (SLM).

14. The non-transitory machine-readable medium of claim 13, wherein the operations further comprise fine tuning the generative pre-trained transformer model, the fine tuning comprising:
collecting communication session content data from a plurality of network-based communication sessions;
labeling the collected communication session content data with corresponding workflows and outcomes; and
fine-tuning the generative pre-trained transformer model using the labeled collected communication session content data to refine the weights and biases of the generative pre-trained transformer model to learn relationships between communication session content data, workflows, and outcomes.

15. A computing device for analysis of unsatisfactory responses of an artificial intelligence (AI) based engine during network-based communication sessions, the computing device comprising:
a hardware processor;
a memory, the memory storing instructions, which when executed by the hardware processor cause the computing device to perform operations comprising:
receiving a first user input;
providing a response to the first user input using the AI based engine;
receiving a second user input;
determining, using the AI based engine, that a context of the second user input is about the response to the first user input previously given by an AI based engine;
responsive to determining that the second user input relates to the response to the first user input previously given by an AI based assistant:
determining a transformer sequence of the meeting workflow of the AI-based engine that most probably caused the response to the first user input by:
utilizing a scoring generative artificial intelligence model to calculate the transformer sequence based upon communication session content data and trained weights and biases of the AI based engine to a scoring generative artificial intelligence model, the communication session content data comprising one or more of: audio frames, video frames, a transcript, screensharing data, chat messages, communication session modes, human-AI interaction canvases, the first user input, and the response to the first user input, the transformer sequence a data format that encapsulates the communication session content data;
converting the transformer sequence to a session workflow by vectorizing the transformer sequence and comparing the vectorized transformer sequences to stored vectorized session workflows of the network-based communication session, the session workflows being a textual representation of events of the network-based communication session;
inputting the session workflow converted from the transformer sequence to the scoring generative artificial intelligence model to produce a natural language response to the second user input; and
providing the natural language response to a user.

16. The computing device of claim 15, wherein the communication session content data includes metadata including timestamps and participant identifiers.

17. The computing device of claim 15, wherein converting the transformer sequence to the communication session workflow comprises selecting the stored vectorized meeting workflow with a lowest cosine similarity to the vectorized transformer sequence.

18. The computing device of claim 15, wherein the operations further comprise: during the network-based communication session, updating the stored vectorized session workflows based upon new meeting content data received during the meeting.

19. The computing device of claim 15, wherein the operations further comprise storing the natural language response and the associated session workflow in a database that is indexed and vectorized based upon a workflow.

20. The computing device of claim 15, wherein the scoring generative artificial intelligence model is one of: a Large Language Model (LLM), generative pre-trained transformer (GPT) model, a small language model (SLM).
